(19) United States
(12) Patent Application Publication
(10) Pub. No.: US 2013/0084383 A1
(43) Pub. Date: Apr. 4, 2013

(54) METHOD AND ARRANGEMENT OF CROSSLINKING OR VULCANISING AN ELONGATE ELEMENT

(71) Applicant: Esa KARVONEN, Oulu (FI)

(72) Inventor: Esa KARVONEN, Oulu (FI)

(73) Assignee: MAILLEFER S.A., Ecublens (CH)

(21) Appl. No.: 13/604,126

(22) Filed: Sep. 5, 2012

(30) Foreign Application Priority Data
Sep. 30, 2011 (FI) 20115960

(51) Int. Cl. B05C 5/02; B05D 3/02

(52) U.S. Cl. CPC B05C 5/0241; B05D 3/0245
USPC 427/120; 118/68

(57) ABSTRACT

A method and arrangement of crosslinking or vulcanising an elongate element in which method a conductor element is coated by a layer of crosslinkable synthetic material in an extrusion step and the crosslinking reaction is carried out after the extrusion step. The conductor element is pre-heated in a pre-heating step before the extrusion step by generating inductively eddy currents inside the conductor element which will heat up the conductor element. The pre-heating step is carried out by increasing temperature of the conductor element gradually so that temperature difference between outermost region of the conductor element and the inner layer of the conductor element remains below a pre-determined level at the end of the pre-heating step.

The invention relates to a method of crosslinking or vulcanising an elongate element in which method a conductor element is coated by a layer of crosslinkable synthetic material in an extrusion step and the crosslinking reaction is carried out after the extrusion step and further in which method the conductor element is pre-heated in a pre-heating step before the extrusion step by generating inductively eddy currents inside the conductor element which will heat up the conductor element. The invention relates also to an arrangement for crosslinking or vulcanising an elongate element.

The present invention deals with a method and arrangement for inductive heating of electrical conductors used in the manufacturing of electrical wires and cables. It is directed at increasing the productivity of an electrical cable manufacturing line producing cables that have an insulation structure with at least one layer of crosslinked polyethylene, in particular medium and high voltage energy cables.

One widely used construction of energy transmission cables for medium and high voltage consist of an electrical conductor (Cu or Al), insulated with one or several layers of plastic material, very often polythylene. This insulation is applied onto the conductor in a per se known extrusion process. In order to provide sufficient mechanical and electrical strength, the extruded thermoplastic polymer material is crosslinked.

One method known in the prior art and widely used in the field for crosslinking is the peroxide crosslinking process. In this well-known process, peroxide is added to the thermoplastic material, which, under the effect of temperature, will eventually trigger the chemical reaction leading to the crosslinking of the polymer.

The principle layout of a vulcanising extrusion line is generally composed of a payoff, a metering capstan, a conductor preheater, an extrusion group with extrusion head, a postheater, a vulcanising tube, a cooling tube, a caterpillar or capstan and a take-up. Operation of such an extrusion line and its components are known per se and need not be discussed further. Note that in other line setups, the preheater can be placed upstream of the metering capstan.

In the manufacturing process described above, the insulation has to be extruded onto the conductor at a temperature sufficiently low as to avoid premature crosslinking in the extrusion equipment, as this would lead to defects of the insulation. After the extrusion step, the material has to be heated up at a temperature that is sufficiently high to start and complete the chemical reaction within the shortest possible time.

The crosslinking reaction is carried out in the vulcanisation tube, i.e. a tube surrounding the extruded electrical cable located downstream of the extrusion head, inside which the cable is heated up by radiant and/or convective heat transfer. The heat diffusion in the insulation is however low, and the polymer layers close to the conductor element will take the longest time to increase temperature and undergo the chemical reaction.

A method known in the prior art to improve this heating/crosslinking process is to pre-heat the conductor prior to the extrusion step. This preheating is obtained by means of inductively generating eddy currents inside the conductor element which will heat up the conductor element. Therefore, heat is transferred into the insulation structure from inside the cable, and the heating/crosslinking process completes in shorter time. Such inductive heating elements have been known and used for a long time. Said inductive heating elements are used as pre-heaters upstream of the extrusion head and as post-heaters downstream of the extrusion head and along the vulcanisation tube. As an example of the arrangements discussed above CH Patent No. 644 548 can be mentioned.

The amount of preheating and the beneficial effect on productivity is however limited with the known arrangements for the following reason. In most energy cable constructions, the conductors are stranded wires consisting of multiple layers of wires. Preheaters used for conductor preheating use frequencies in the range of 7-20 kHz. The penetration depth of the magnetic field created by said preheaters into the conductor is limited. Especially in conductors with large cross-sections, the preheaters used heat up only the outermost layers of stranded wires of the conductor. Owing to said fact the temperature of outermost layer rises quickly, while the temperature rises with a certain delay at the core of the conductor. At the exit of the preheater, temperatures between outermost and innermost layers differ by a certain amount DT. The value of this difference DT depends on the intensity of the eddy currents and the duration of exposure of the conductor to the electrical field, i.e. the length of the preheater divided by the line speed. Downstream of the preheater, the temperature would substantially equalize over the cross-section of the conductor to an average temperature Tm within a certain time, depending on the size of the conductor and the temperature difference DT.

If the temperature difference DT gets large enough, differential thermal expansion between the outermost and inner layers will lead to loss of contact between layers and eventually to opening up of the conductor. As a consequence not only the heat is no longer transferred to the inner layers of wires of the conductor, but plastic material may penetrate between the outermost wires. In extreme cases, thermal expansion may be such that the conductor gets stuck in the wire-guide in the extrusion head.

Owing to the facts above, the rate of pre-heating that can be applied to the conductor, and as a consequence the conductor temperature obtained, is limited.

The matters discussed above are problems of the prior art. The object of the invention is to obtain a method and an arrangement by which the problems of the prior art can be solved. This is obtained with the invention. The method of the invention is characterized in that the pre-heating step is carried out by increasing temperature of the conductor element gradually so that temperature difference between outermost region of the conductor element and the inner layer of the conductor element remains below a pre-determined level at the end of the pre-heating step. The arrangement of the invention is characterized in that the device carrying out pre-heating is arranged to increase temperature of the conductor element gradually so that temperature difference between outermost region of the conductor element and the inner layer of the conductor element remains below a pre-determined level at the exit of the device carrying out pre-heating.

An advantage of the invention is in that is solves the problems of the prior art discussed above. In other words the invention offers a method and an arrangement by which it is possible to increase the conductor temperature prior to the extrusion step to higher levels than previously possible, in order to boost production speed of the extrusion line.

In the following the invention will be described in greater detail with reference to embodiments shown in the attached drawing, whereby

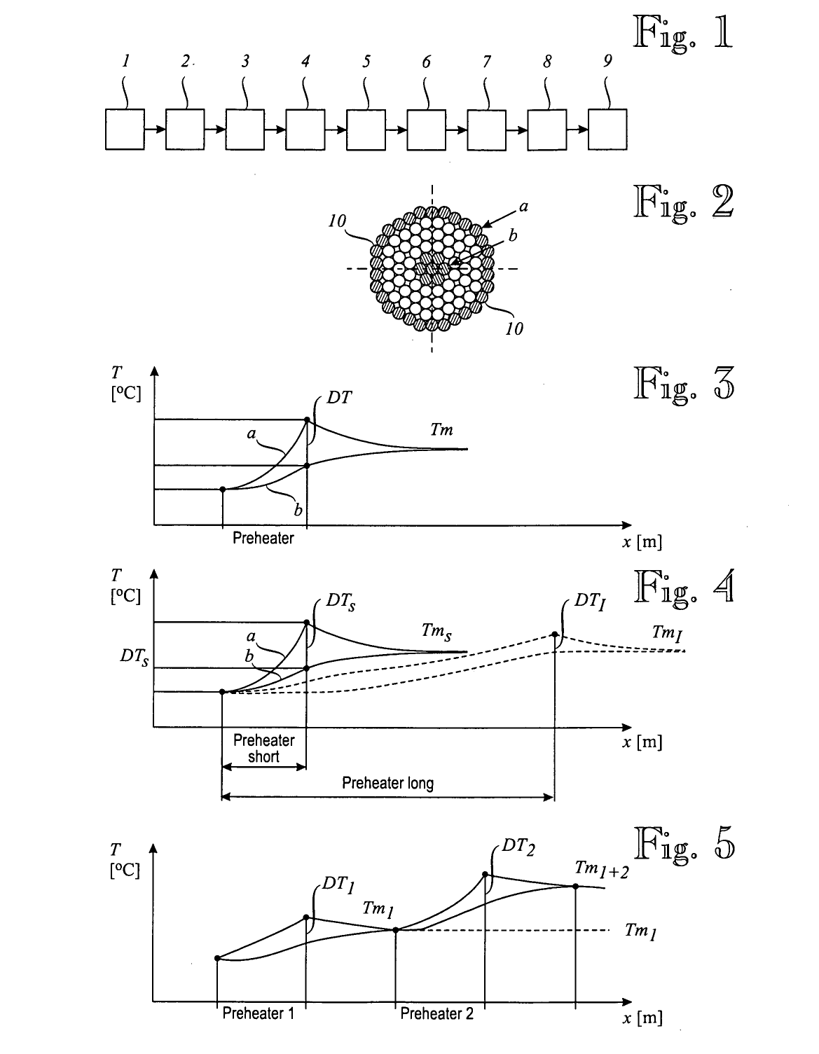

FIG. 1 shows a principle layout of a vulcanising extrusion line,

FIG. 2 shows a schematical cross section of a conductor element,

FIG. 3 shows a schematical temperature profile in a conductor element along a typical prior art pre-heater,

FIG. 4 shows a schematical temperature profile in a conductor element along an embodiment of the pre-heater of the present invention and compared to the typical prior art solution and

FIG. 5 shows a schematical temperature profile in a conductor element along another embodiment of the pre-heater of the present invention.

FIG. 1 shows a principle layout of a vulcanizing extrusion line. The vulcanising extrusion line comprised a payoff 1, a metering capstan or metering caterpillar 2, a preheater 3 for a conductor element, as extrusion group with an extrusion head 4, a postheater 5, a vulcanising tube 6, a cooling tube 7, a caterpillar or a capstan 8 and a take-up 9. As said earlier operation of the extrusion line described above is well-known to a person skilled in the art, and therefore operation or/and construction of the extrusion line is not described in detail here.

FIG. 2 shows schematically a typical conductor element consisting stranded wires 10. As shown in FIG. 2 the conductor element comprises multiple layers of wires 10. In FIG. 2 reference a shows the outermost region or layer of the conductor element and reference b shows the inner layer, i.e. the core layer of the conductor element.

As told earlier it has been known for long that insulation layer has been applied onto the conductor element by using an extruder. Said insulation layer consisting for example of thermoplastic polymer material, has been applied onto the conductor and crosslinked. Said crosslinking has been carried out by using a peroxide crosslinking process in which the effect of temperature triggers the chemical reaction leading to the crosslinking of the polymer. The crosslinking reaction has been carried out in the vulcanising tube 6. The heat diffusion in the insulation layer is however low, and therefore the polymer material close to the conductor element takes rather long time to increase temperature and undergo the chemical reaction when compared to the outermost layer of the polymer material of the insulation layer. In order to improve the situation it has been known in the field to improve the crosslinking process by pre-heating the conductor element prior to the extrusion step. Said pre-heating has been carried out inductively, i.e. by generating eddy currents inside the conductor element which heats up the conductor element. This means in practice that heat is transferred into the insulation layer extruded also from inside, and therefore said crosslinking process is speeded up.

FIG. 3 shows a schematical temperature profile in a conductor element along a typical prior art pre-heater. As shown in FIG. 3 the temperature of the outermost layer a rises rather quickly. The temperature in the inner layer b rises clearly slowly when compared to the temperature of the outermost layer a. At the exit of the pre-heater temperatures between the outermost layer and the inner layer differ by a certain amount shown by the reference DT in FIG. 3.

As discussed above the value of the difference DT depends on the intensity of the eddy currents and the duration of exposure of the conductor element to the electrical field. Downstream of the pre-heater, the temperature substantially equalizes over the cross-section of the conductor element to an average temperature Tm within a certain time, depending on the size of the conductor element and the temperature difference DT.

It must be noted here that if the temperature difference DT gets large enough, differential thermal expansion between the outermost layer and the inner layer leads easily to loss of contact between said layers and eventually to opening up of the wires of the conductor element. As a consequence not only the heat is no longer transferred to the inner layers of wires of the conductor element, but plastic material may penetrate between the wires of the outermost layer. In extreme cases, thermal expansion may be such that the conductor element gets stuck in the wire-guide in the extrusion head. The problem described above is pretty severe especially with aluminium conductors due to oxidized surface of wires, and also in wires covered with lacquer.

The matters described above mean that the rate of pre-heating that can be applied to the conductor element, and as a consequence the conductor temperature obtained, is limited.

FIG. 4 shows schematically the basic principle of the invention when compared to the prior art. The prior art is shown by describing how the temperatures rise in a short pre-heater. This part of FIG. 4 corresponds to FIG. 3. The temperature difference between the outermost layer a and the inner layer b of the conductor part at the exit of said short pre-heater is shown with a reference DTs. Average temperature after said short pre-heater is shown with a reference Tms in FIG. 4. According to the basic idea of the invention the pre-heating step is carried out by increasing temperature of the conductor element slower, i.e. gradually so that temperature difference between outermost layer or region a of the conductor element and the inner layer b of the conductor element remains below a pre-determined level at the end of the pre-heating step. In other words with the invention it is possible to obtain essentially the same average temperature as obtained with the prior art but with clearly smaller temperature difference DT1 at the exit of the pre-heater. It is also possible with the invention to obtain higher line speeds that by using the prior art. This is because the temperature difference at the exit of the pre-heater can always in all operating conditions can be kept below a certain pre-determined level This means that the disadvantages of the prior art described above can be eliminated.

In the embodiment of FIG. 4 a long pre-heater is used, and the effect of the long coil, i.e. a long pre-heater is shown with dotted lines in FIG. 4. The temperature difference at the exit of the long pre-heater is shown with a reference DT1 in FIG. 4. Average temperature after said long pre-heater is shown with a reference Tm1 in FIG. 4. FIG. 4 shows clearly that DT1 is smaller than DTs.

Due to the longer exposure, the induced power can be reduced and therefore the temperature difference between the outermost layer a and the inner layer b of the conductor element is reduced to an acceptable level. The length of the pre-heater can be dimensioned so that a certain pre-determined level is reached for DT1. FIG. 4 shows basically an embodiment of the invention in which longer exposure with reduced power is carried out in one continuous step. This is however not the only possibility but it is possible to materialize the basic idea of the invention also in other ways.

FIG. 5 refers schematically to an embodiment in which the heating step is carried out with two successive steps, i.e. by using a pre-heater 1 and a pre-heater 2. In the embodiment of FIG. 5 said two pre-heaters, i.e. induction coils, are placed at intervals so that the temperature inside the conductor element evolves in a way that the temperature difference between the outermost layer and the inner layer does not lead to excessive thermal expansion differences between the wires of the conductor element. The temperature differences at the exits of the pre-heaters are shown with references DT1 and DT2 in FIG. 5.

In the embodiment of FIG. 5 the two pre-heaters are placed at a distance to each other. Induction power is maintained at a level so that no detrimental expansion occurs at the exits of the pre-heaters. The distance of the first pre-heater to the second pre-heater is determined so that the temperature in the conductor element becomes uniform across the conductor element before the conductor element enters the second pre-heater. Said uniform temperature, i.e. the average temperature after the first pre-heater, is shown with reference Tm1 in FIG. 5. In the second pre-heater, the average conductor element temperature is raised to a substantially higher level without damaging the conductor element. The average temperature after the second pre-heater is shown with reference Tm1+2 in FIG. 5.

The embodiment of FIG. 5 uses two pre-heaters. It is however quite possible to use more than two pre-heaters placed with pre-determined distances to each other in the way as described above in connection with the embodiment of FIG. 5.

When for example two step pre-heating is used it is possible that the first pre-heater is located before the metering capstan or metering caterpillar, i.e. the step shown with reference number 2 in FIG. 1. It is however also possible to locate both pre-heaters after the metering capstan or metering caterpillar, i.e. the step shown with reference number 2 in FIG. 1.

It is also quite possible within the spirit of the invention to use for example two pre-heaters arranged contiguously to each other. This embodiment is advantageous for example in creating a long pre-heater in order to obtain a long and continuous pre-heating step.

The optimum distance between separate successive pre-heaters depends on the pre-heater used and also on production conditions. It is quite possible to make the pre-heaters as a movable construction in order to enable finding of the optimum distance in various production conditions.

The constructions shown are not the only possibilities to materialize the invention but, the constructions may be for example such that pre-heaters or at least one of them can be taken away and arranged to a different position. Alternatively the pre-heaters or at least one of them may be mounted to a movable platform construction. Said movable platform construction may enable either stepwise movement or continuous movement or even both.

The present invention can be supported by using the following data obtained from the field test.

Line: CCV, 10×6 m heating, 145 m water cooling

Al 150 mm2 20 kV (0.7 mm+5.5 mm+0.6 mm):
T(preheat) 20 . . . 110 deg C.→v=19.6 m/min
T(preheat1) 20 . . . 80 deg C.+T(preheat2) 80 . . . 145 deg C.→24.4 m/min

Al 150 mm2 10 kV (0.7 mm+3.4 mm+0.6 mm):
T(preheat) 20 . . . 110 deg C.→31.2 m/min
T(preheat1) 20 . . . 80 deg C.+T(preheat2) 80 . . . 145 deg C.→v=40.0 m/min

The examples shown above prove that by using gradual heating, in these cases stepwise materialized heating step, it is possible to obtain higher line speeds. In other words the invention is clearly beneficial for productivity.

The invention has been described above by using the embodiments described in the Figures. The embodiments shown are by no means intended to restrict the invention but the invention may be varied completely freely within the claims.

1. Method of crosslinking or vulcanising an elongate element in which method a conductor element is coated by a layer of crosslinkable synthetic material in an extrusion step and the crosslinking reaction is carried out after the extrusion step and further in which method the conductor element is pre-heated in a pre-heating step before the extrusion step by generating inductively eddy currents inside the conductor element which will heat up the conductor element, wherein the pre-heating step is carried out by increasing temperature of the conductor element gradually so that temperature difference between outermost region of the conductor element and the inner layer of the conductor element remains below a pre-determined level at the end of the pre-heating step.

2. Method as claimed in claim 1, wherein the pre-heating step is carried out in one continuous step.

3. Method as claimed in claim 1, wherein the pre-heating step is carried out with at least two successive steps.

4. Method as claimed in claim 3, wherein there is a distance between the two successive steps and the distance is determined so that after one step the temperature becomes uniform across the conductor element before another step is carried out.

5. Arrangement for crosslinking or vulcanising an elongate element in which arrangement a conductor element is coated by a layer of crosslinkable synthetic material by using an extrusion head and the crosslinking reaction is carried out after the extrusion head in a vulcanization tube and further in which arrangement the conductor element is pre-heated before the extrusion head by a device arranged to generate inductively eddy currents inside the conductor element which will heat up the conductor element, wherein in that the device carrying out pre-heating is arranged to increase temperature of the conductor element gradually so that temperature difference between outermost region of the conductor element and the inner layer of the conductor element remains below a pre-determined level at the exit of the device carrying out pre-heating.

6. Arrangement as claimed in claim 5, wherein a device inductively creating eddy currents is formed by one induction coil.

7. Arrangement as claimed in claim 5, wherein a device inductively creating eddy currents is formed by at least two successively arranged induction coils.

8. Arrangement as claimed in claim 7, wherein there is a distance between the two successive induction coils and the distance between the two successive induction coils is determined so that after one induction coil the temperature becomes uniform across the conductor element before another induction coil.

9. Arrangement as claimed in claim 7, wherein the two successive induction coils have been arranged contiguously to each other.

10. Arrangement as claimed in claim 7, wherein at least one the induction coils is formed as a movable construction.

11. Arrangement as claimed in claim 8, wherein at least one the induction coils is formed as a movable construction.

12. Arrangement as claimed in claim 9, wherein at least one the induction coils is formed as a movable construction.
